(19) United States
(12) Patent Application Publication
(10) Pub. No.: US 2015/0124626 A1
(43) Pub. Date: May 7, 2015

(54) METHOD OF SUPPORTING IN-BAND OPERATIONS, ADMINISTRATION AND MAINTENANCE (OAM) FOR POINT-TO-MULTIPOINT (P2MP) DATA TRANSFER IN MULTI-PROTOCOL LABEL SWITCHING-TRANSPORT PROFILE (MPLS-TP) NETWORK

(71) Applicant: ELECTRONICS AND TELECOMMUNICATIONS RESEARCH INSTITUTE, Daejeon (KR)

(72) Inventors: Dong Myung SUL, Daejeon (KR); Sun Me KIM, Daejeon (KR); Jong Hyun LEE, Daejeon (KR)

(21) Appl. No.: 14/533,450

(22) Filed: Nov. 5, 2014

(30) Foreign Application Priority Data
Nov. 5, 2013 (KR) 10-2013-0133574
Jun. 9, 2014 (KR) 10-2014-0069489

(51) Int. Cl. H04L 12/26; H04L 29/06; H04L 12/911; H04L 12/723

(52) U.S. Cl. CPC H04L 43/00; H04L 45/50; H04L 69/22; H04L 47/825
USPC 370/241.1

(57) ABSTRACT

A method of supporting in-band Operations, Administration and Maintenance (OAM) in a Multi-Protocol Label Switching-Transport Profile (MPLS-TP) network is provided. The method may include generating a merged OAM packet by merging a plurality of OAM packets received from a plurality of leaf nodes, and transmitting the merged OAM packet to a root node through a Label-Switched Path (LSP).

### CROSS-REFERENCE TO RELATED APPLICATIONS

This application claims the benefit of Korean Patent Application No. 10-2013-0133574 and of Korean Patent Application No. 10-2014-0069489, respectively filed on Nov. 5, 2013 and Jun. 9, 2014, in the Korean Intellectual Property Office, the disclosures of which are incorporated herein by reference.

### BACKGROUND

1. Field of the Invention

The following embodiments relate to a method of supporting Operations, Administration and Maintenance (OAM) in a Point-to-Multipoint (P2MP) data transfer in a Multi-Protocol Label Switching-Transport Profile (MPLS-TP) network.

2. Description of the Related Art

A Multi-Protocol Label Switching (MPLS) technology stabilized by an Internet Engineering Task Force (IETF) may provide a connection-oriented packet service by labeling packets of various services using a layer 2.5 function, to improve inefficiency of Internet Protocol (IP) packet switching. The MPLS technology may be applied to various protocols, for example, an IP, Asynchronous Transfer Mode (ATM), frame relay, and the like. Additionally, the MPLS technology as a high-speed label switching technology of processing packets based on labels, may allow packets to be transmitted at a higher speed by identifying path information of a layer 3 and a network layer with a label or a tag, instead of calculating a path of each packet in an access communication network, for example an ATM.

Due to requirements of connection-oriented transmission functions of various Time-Division Multiplexing (TDM) services and packet services through the above optical network, in addition to development of a Wavelength-Division Multiplexing (WDM) transmission network, a necessity of a transmission infrastructure to integrate WDM transmission networks to be reliable at a minimum cost per unit bit has been raised in all types of client traffic (for example, multi-services) and in scalability of various service networks.

To this end, an MPLS-Transport Profile (TP) standardization may be performed by an MPLS-TP Joint Working Team (JWT) between the IETF and the International Telecommunication Union-Telecommunication Standardization Sector (ITU-T) Study Group (SG) 15. In other words, the MPLS-TP may store profiles required for transmission while maintaining existing MPLS architecture and forwarding function. Additionally, a main purpose of the MPLS-TP is to provide a transmission network that has flexibility and efficiency in terms of operations and that is low in price, based on a packet service, as a new paradigm of a transmission infrastructure through functional improvement of protection and Operations, Administration and Maintenance (OAM).

Standardization of the MPLS-TP being developed by the ITU-T SG15 and the IETF includes OAM, survivability, network management, control plane protocol development, and the like.

The MPLS-TP may use a distributed control plane to enable service provisioning that is quick, dynamic and reliable in a plurality of vendors and domain environment. An MPLS-TP control plane may use a Label Distribution Protocol (LDP) for Pseudowire (PW) signaling, based on a combination of an MPLS control plane for PWs and a Generalized MPLS (GMPLS) control plane for Label-Switched Paths (LSPs). Additionally, the MPLS-TP control plane may use Resource Reservation Protocol (RSVP)-Traffic Engineering (TE) for LSP signaling, and may use Open Shortest Path First (OSPF)-TE and Intermediate System to Intermediate System (ISIS)-TE for LSP routing. It may be possible to statically configure an LSP and a PW, instead of using the MPLS-TP control plane. A main function of the MPLS-TP control plane may include signaling, routing, TE, constraint-based path calculation, responding to OAM, survivability of the MPLS-TP control plane, and the like. The survivability may indicate, for example, that the MPLS-TP control plane may be decoupled from a data plane and may operate independently of a mutual failure.

### SUMMARY

An aspect of the present invention provides a technology for processing Operations, Administration and Maintenance (OAM) packets for protection switching within 50 milliseconds (ms) that is one of requirements of Multi-Protocol Label Switching-Transport Profile (MPLS-TP) OAM.

Another aspect of the present invention provides a technology for more efficiently processing an OAM packet that is generated by a root node merging OAM packets received from leaf nodes and that is received through a single Label-Switched Path (LSP).

According to an aspect of the present invention, there is provided a method of supporting OAM in a network including a root node and a plurality of leaf nodes. The method may include generating a merged OAM packet by merging a plurality of OAM packets received from the leaf nodes, and transmitting the merged OAM packet to the root node through an LSP.

The generating may include merging a Continuity Check (CC) OAM packet and a Connectivity Verification (CV) OAM packet.

A frame of each of the OAM packets may include a Generic Associated Channel (G-ACh) field, and the G-ACh field may be used to distinguish OAM control data from user data.

Each of the OAM packets may include a Bidirectional Forwarding Detection (BFD) control packet, and the transmitting may include verifying an address of the root node based on the BFD control packet.

The transmitting may include assigning a Bandwidth (BW) to the LSP.

The method may further include processing the merged OAM packet in the root node.

The transmitting may include transmitting the merged OAM packet via the same channel as a channel of a packet of user data.

According to another aspect of the present invention, there is provided a method of transmitting an OAM packet in a network including a root node and a plurality of leaf nodes, the method including determining whether the OAM packet includes a BFD control packet, determining whether the root node supports processing of a merged OAM packet, generating a merged OAM packet by merging a plurality of OAM packets, when the OAM packet is determined to include the BFD control packet and when the root node is determined to support processing of the merged OAM packet, and transmitting the merged OAM packet to the root node through an LSP.

According to another aspect of the present invention, there is provided a router for supporting OAM in a network including a root node and a plurality of leaf nodes. The router may include a processor to generate a merged OAM packet by merging a plurality of OAM packets received from the leaf nodes, and a transmitter to transmit the merged OAM packet to the root node through an LSP.

The processor may generate a merged OAM packet by merging a CC OAM packet and a CV OAM packet.

A frame of each of the OAM packets may include a G-ACh field, and the G-ACh field may be used to distinguish OAM control data from user data.

Each of the OAM packets may include a BFD control packet, and the transmitter may verify an address of the root node based on the BFD control packet.

The transmitter may assign a BW to each of LSPs of the merged OAM packet directed toward the root node.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a frame format of a Multi-Protocol Label Switching-Transport Profile (MPLS-TP) Label-Switched Path (LSP) Operations, Administration and Maintenance (OAM);

FIG. 2 is a diagram illustrating an in-band channel and an out-of-band channel;

FIG. 3A and FIG. 3B are diagrams illustrating a Point-to-Multipoint (P2MP) return path;

FIG. 4 is a diagram illustrating a format of an MPLS-TP Bidirectional Forwarding Detection (BFD) Continuity Check (CC)/Connectivity Verification (CV) OAM control packet;

FIG. 5 is a diagram illustrating a scheme of transmitting P2MP in-band OAM packets by merging LSPs according to an embodiment;

FIG. 6 is a block diagram illustrating a configuration of a router according to an embodiment;

FIG. 7 is a flowchart illustrating a method of supporting OAM in an MPLS-TP network according to an embodiment; and

FIG. 8 is a flowchart illustrating a method of selecting an OAM support scheme in a router in an MPLS-TP network according to an embodiment.

### DETAILED DESCRIPTION

Particular structural or functional descriptions of embodiments according to the concept of the present invention disclosed in the present disclosure are merely intended for the purpose of describing embodiments according to the concept of the present invention, and the embodiments according to the concept of the present invention may be implemented in various forms and should not be construed as being limited to those described in the present disclosure.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not construed as an ideal or excessively formal meaning unless otherwise defined herein.

Hereinafter, embodiments will be further described with reference to the accompanying drawings.

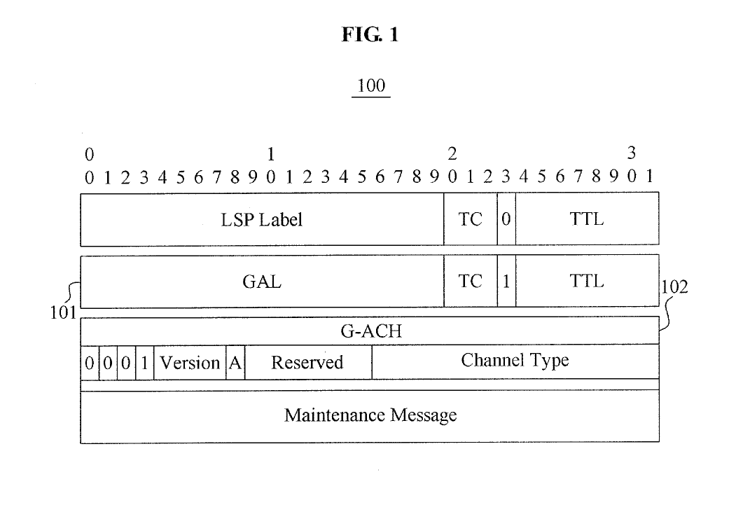

FIG. 1 illustrates a frame format of Multi-Protocol Label Switching-Transport Profile (MPLS-TP) Label-Switched Path (LSP) Operations, Administration and Maintenance (OAM).

An MPLS technology standardized by an Internet Engineering Task Force (IETF) may refer to a high-speed label switching technology for processing packets based on labels.

An LSP in MPLS may refer to a path through which labels are exchanged between MPLS switches in both ends of a public Internet network end.

OAM is a term used to describe processes, activities, tools, standards, and the like involved with operating, administering, maintaining, provisioning, troubleshooting, and the like of a system. The operating refers to an operation process for allowing each element of a network to be stably provided as a service. The administering refers to an efficient management scheme for operations, and the maintaining refers to a precaution activity for availability of services. The provisioning refers to configuring new hardware or services, and the troubleshooting refers to providing a diagnosis, knowledge, a guide, and a process for troubleshooting.

MPLS-TP OAM may be applied to a section, an LSP, and a PW layer. A Maintenance Entity (ME) defined in the MPLS-TP OAM may be, for example, a Section ME (SME), an LSP ME (LME), a PW ME (PME), an LSP Tandem Connection ME (TLME), an MS-PW Tandem Connection ME (TPME), and the like. The SME may monitor and manage an MPLS-TP section between Label Switching Routers (LSRs), and the LME may monitor and manage an Edge-to-Edge (E2E) LSP between Label Edge Routers (LERs). The PME may monitor and manage an E2E Single-Segment (SS)-PW and/or Multi-Segment (MS)-PW between Terminating Provider Edges (TPEs), and the TLME may monitor and manage an LSP tandem connection or an LSP segment between an LER and an arbitrary LSR. Additionally, the TPME may monitor and manage an SS/MS-PW tandem connection or a PW section between a TPE and an arbitrary Switching Provider Edge (SPE).

A function defined in the MPLS-TP OAM may be, for example, Continuity Check (CC), Connectivity Verification (CV), performance monitoring, alarm suppression, remote integrity, on-demand/continuous operation, and the like.

Referring to FIG. 1, to support a Fault, Configuration, Accounting, Performance, Security (FCAPS), an MPLS-TP may use a Generic Associated Channel (G-ACh) 102 similar to an ACh of a Pseudowire Emulation Edge-to-Edge (PWE3). Whether the G-ACh 102 is included in a packet 100 may be indicated by a G-ACh label (GAL) 101. The GAL 101 may be located on a bottom of a label stack.

The CC may be performed to detect an error in connectivity and continuity between a pair of Maintenance Entity Group End Points (MEPs) of an ME, and may also be used to detect an address of a Media Access Control (MAC) of a counterpart MEP. A continuity error may occur due to a software fault, for example a broken memory, or incorrect setting, or due to a hardware fault, for example a power failure or link end.

To check continuity of an end, a CC OAM message may be periodically generated, and may continue to be transmitted by an MEP included in the end. For example, when a first CC OAM message is received from a specific MEP, a reception MEP may verify connectivity with a transmission MEP, and may expect to periodically receive a CC OAM message. When periodical reception of the CC OAM message from the transmission MEP is interrupted, the reception MEP may recognize that the reception MEP is disconnected from the transmission MEP. An MEP that detects the above defect in the connectivity may notify a user of the defect, may generate an alarm suppression signal for an upper layer, may initialize a defect verification routine, and may isolate the defect.

Similarly, in a multi-Ethernet connection with N MEPs, a CC OAM message may be received from N−1 MEPs, and may be processed by a CC scheme similar to an end including a pair of MEPs. All Maintenance Entity Group Intermediate Points (MIPs) may forward CC OAM packets as normal packets.

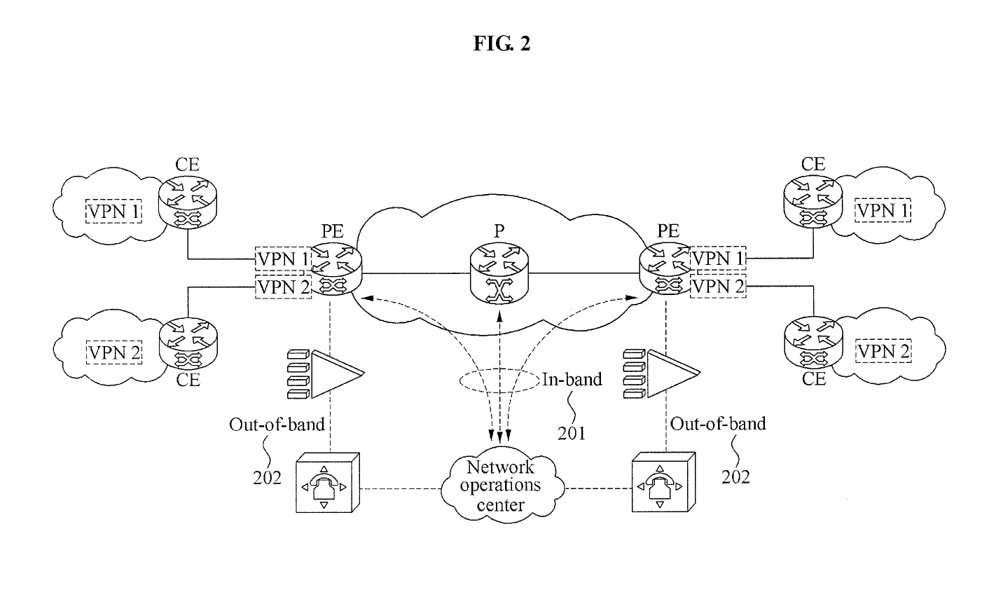

FIG. 2 illustrates an in-band channel and an out-of-band channel.

Traffic flowing through a physical link in network equipment may be divided into user data and control data for management. Referring to FIG. 2, an in-band 201 may indicate that control traffic of control data and user traffic of user data flow via the same channel. An out-of-band 202 may indicate that the control traffic is separated from a user channel via which the user traffic flows, and flows via a separate channel.

An out-of-band channel may be physically different links, or a virtual interface of the same link. For example, to control an LSP intermediate node in MPLS equipment, a scheme of adding a G-ACh to a header and using the G-ACh together with user data, similarly to MPLS OAM, may be referred to as an in-band scheme. A scheme of generating a PW or a tunnel for management, or accessing a corresponding node through physically different links may be referred to as an out-of-band scheme.

An MPLS control message may be classified as follows, based on Request for Comments (RFC) 6373:

An in-band MPLS control message may indicate that user traffic and control traffic are transmitted through the same channel. By adding an MPLS G-ACh to a header, user data and control data may be distinguished from each other.

In an “out-of-band, in-fiber (same physical connection),” user data and control data may be separated from each other, using a dedicated LSP for management on the same physical link.

In an “out-of-band, aligned topology,” user traffic and control traffic may be transmitted via different links, and non-overlapping path may be used.

In “out-of-band, independent topology,” management traffic may be completely independent of data including a method of using different links.

A P2MP communication scheme may refer to a communication scheme of providing data via multicast by connecting a single root node and a plurality of leaf nodes through a plurality of paths. A tree structure may include a root node and a leaf node, and the root node may refer to a top node of the tree structure. For example, when a node A indicates a node B, the node A may be a parent node of the node B, and the node B may be a child node of the node A. A leaf node may refer to a node that does not have a child node. Supporting of P2MP OAM in a data path may be irrelevant to a return path and availability of a mechanism for supporting a return path. Basically, in an MPLS-TP, only unidirectional P2MP may be supported.

Connection merging may be often used in different networks. For example, linear protection switching (for example, 1+1 SDH VC-n SNC/N, 1:1 ODUk SNC/S) may include a form of merging. Additionally, a connection wire currently being used, and a reserve connection wire may be merged at a tail end of a protected domain. An explicit set of forwarding rules that are controlled by a protection switch controller may prevent an error from occurring.

A merging scheme may exist in a Rooted Multipoint (RMP) and Multipoint-to-Multipoint (MP2MP) Ethernet Virtual Connections (VCs). The above merging may not have a problem in correct OAM support.

A connection of a Point-to-Point (P2P) Evolved Packet System (EPS) to Provider Backbone Bridge (PBB)-TE may be performed by a Multipoint-to-Point (MP2P) EPS sublayer connection. The MP2P EPS sublayer connection may be merely used to enhance scalability of a switching table of a core node P of the PBB-TE. All monitoring based on MP2P connection merging may be performed based on P2P EPS connections. Typically, MP2P connections may have application space, and may maintain OAM designed to operate in an MP2P connection (for example, OAM such as Y.1731).

In the MPLS-TP, LSP merging may be used in MP2P in the following examples:

For example, N Provider Edge (PE) nodes connected to each other by a full mesh of P2P E2E LSPs may be assumed to exist. Each of the E2E LSPs may be mapped to an MP2P E2E tunnel (E2ET) LSP (N−1 input ports, and a single output port). In a P2P E2E LSP packet fetched from each label stack entry header, a label field may need to have a value that is unique within the MP2P E2ET LSP. Each MP2P E2ET LSP packet may have a label stack entry header in which a label field has a value used to distinguish the E2ET LSP from one of the other E2ET LSPs. A node P between the N PE nodes may forward a packet based on an E2ET LSP label value. Based on forwarding of a corresponding packet, a reception PE may uniquely identify LSP packets by a P2P edge. An MP2P E2ET LSP connection may be monitored for connectivity and continuity problems using properly designed CC/CV OAM (similar to CCM OAM). In a normal example, the MP2P E2ET LSP connection may not monitor for a packet loss. However, a packet loss may be monitored in a P2P E2E LSP connection.

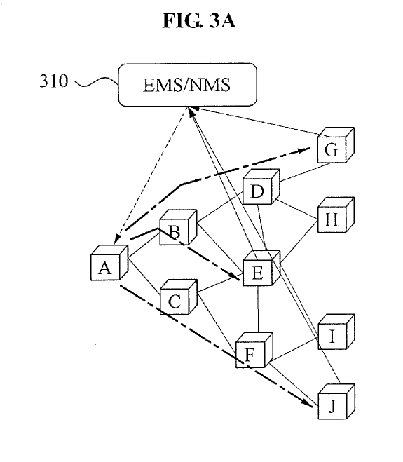

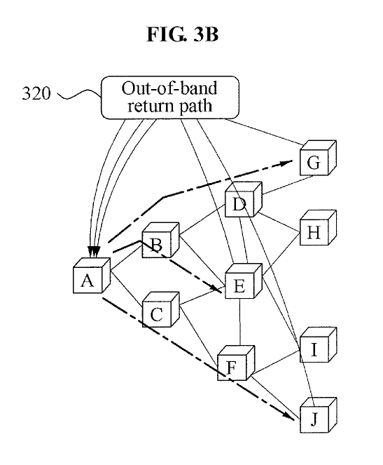

FIGS. 3A and 3B illustrate a P2MP return path.

A current P2MP return path uses two schemes as shown in FIGS. 3A and 3B.

Referring to FIG. 3A, a Return Path-None (RP-N) scheme may use a return path using an existing EMS/NMS management interface 310, instead of setting a new return path. In this example, an in-band return path may not exist.

Referring to FIG. 3B, a Return Path-Head End (RP-HE) may support a P2MP return path, using an out-of-band path 320 that uses a network different from an in-band path.

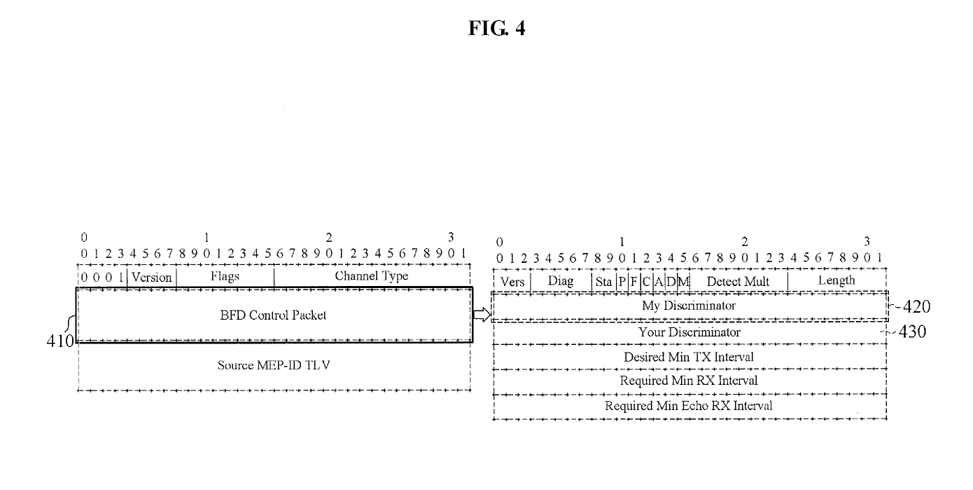

FIG. 4 illustrates a format of an MPLS-TP Bidirectional Forwarding Detection (BFD) CC/CV OAM control packet.

When traffic of N different sources is transmitted toward a single destination in all networks, the traffic may be merged. Resources used to transmit the merged traffic may need to be reserved, and whether a correct departure source (address) of the merged traffic is discriminable may need to be determined. A typical transmission label may not include resource requirements in which sources and each connection are approved.

Referring to FIG. 4, an MPLS-TP BFD CC/CV OAM control packet 410 may include source information of a root node and source information of a leaf node. BFD may refer to a protocol provided by the IETF to detect a failure occurring in two forwarding paths.

A My Discriminator field 420 may be set to a value that is unique in a transmission system and that is generated by the transmission system as a value of an identification (ID) of a node configured to generate and transmit an OAM packet. A Your Discriminator field 430 may be set to a value that is unique in the transmission system and that is generated as an ID of a node to receive an OAM packet. When a reception node is not specified, a value of “0” may be set.

Merging of traffic may have a problem in management of a Bandwidth (BW), that is, physical media. A 13W resource may be divided into small pieces, and each of the pieces may be assigned to a transmission path (for example, an E2E LSP) of each of transmission path layers, and a connection of Virtual Paths (VPs) may have a BW. A piece of a BW of each of the VPs may be assigned to a transmission service layer transmission path (for example, an MS-PW, or a service-LSP).

A BW resource per transmission path of a transmission service layer may not be divided into pieces. For example, E2E LSPs may be used as a scalable transmission entity of a domain, and may have a unspecific BW. A portion of each of BW resources may be assigned to a transmission service layer transmission path (for example, an MS-PW, or a service-LSP).

According to an embodiment, a BW of an LSP directed from an LSR between a root node and a leaf node toward the root node may need to be assigned. Because only MP2P OAM packets may be merged and transmitted, only a BW required to transmit OAM packets may need to be secured. Accordingly, a BW of an LSP may be set to a sum of BWs required to transmit OAM packets for each of LSPs to be merged.

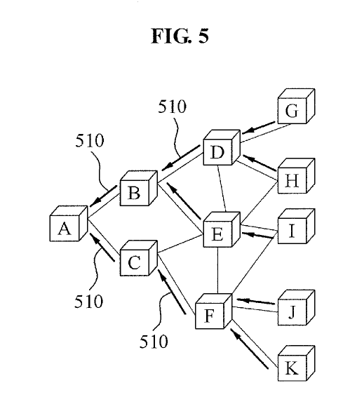

FIG. 5 illustrates a scheme of transmitting P2MP in-band OAM packets by merging LSPs according to an embodiment.

Referring to FIG. 5, in LSRs B, C, D, E, and F between a root node A and leaf nodes G, H, I, J, and K, OAM packets 510 transmitted from the leaf nodes G, H, I, J, and K to the root node A may be merged, and may be transmitted through a single LSP. For example, in P2MP, in-band OAM packets transmitted from the leaf nodes G, H, I, J, and K may be transmitted to the root node A by merging LSPs in the LSRs B, D and F.

For in-band OAM, whether merging of OAM packets is possible may need to be determined based on requirements that is described below. An LSR may need to support merging of OAM packets. For example, when a router does not support merging of OAM packets, in-band OAM may not be supported. Additionally, a root node may need to process a merged OAM packet. Furthermore, a BW of an LSP directed toward the root node may need to allow a merged OAM packet to be transmitted. In addition, an OAM packet may need to include BFD control packet information. BFD may refer to a protocol provided-by the IETF to detect a failure occurring in two forwarding paths, may be easily and simply implemented, and may have low overhead. In BFD, a session may be set to detect a bidirectional forwarding path state (for example, an up state or a down state) between neighboring network apparatuses, and a failure (for example, the down state) may be determined to occur when a BFD control packet is not received from a counterpart during a predetermined period of time. Information on a Your Discriminator field (for example, the Your Discriminator field 430 of FIG. 4) included in the BFD control packet information may need to be identical to information of a root node. Additionally, information on a My Discriminator field (for example, the My Discriminator field 420 of FIG. 4) included in the BFD control packet information may need to be identical to information of a leaf node.

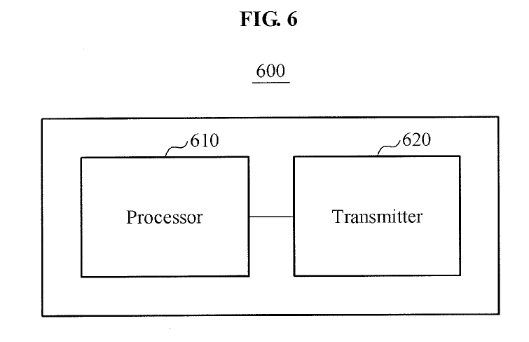

FIG. 6 is a block diagram illustrating a configuration of a router 600 in an MPLS-TP network according to an embodiment.

Referring to FIG. 6, the router 600 may include a processor 610 and a transmitter 620. The processor 610 may generate a merged OAM packet by merging a plurality of OAM packets received from a plurality of leaf nodes. The transmitter 620 may transmit the merged OAM packet to a root node through an LSP.

In an example, the processor 610 may generate a merged OAM packet by merging a CC OAM packet and a CV OAM packet. In another example, the processor 610 may merge a CC OAM packet, a CV OAM packet, a performance monitoring OAM packet, an alarm suppression OAM packet, a remote integrity OAM packet, and an on-demand/continuous operation OAM packet.

A frame of an OAM packet may include a G-ACh field. The G-ACh field may be used to distinguish OAM control data from user data. Whether a G-ACh field is included in a packet may be indicated by a GAL. The GAL may be located on a bottom of a label stack.

An OAM packet may include a BFD control packet. The transmitter 620 may verify an address of the root node based on the BFD control packet. For example, an MPLS-TP BFD OAM packet may include source information of a root node and source information of a leaf node. In the BFD control packet, a My Discriminator field may be set to a value generated by a transmission system as a value of an ID of a node to generate and transmit an OAM packet, and a Your Discriminator field may be set to a value of an ID of a node to receive an OAM packet.

The transmitter 620 may assign a BW to each of LSPs of the merged OAM packet directed toward the root node. Because only MP2P OAM packets may be merged and transmitted, only a BW required to transmit OAM packets may need to be secured. Accordingly, a BW of an LSP may be set to a sum of BWs required to transmit OAM packets for each of LSPs to be merged.

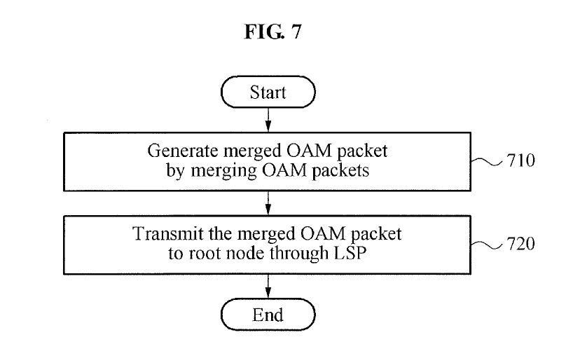

FIG. 7 is a flowchart of a method of supporting OAM in an MPLS-TP network according to an embodiment.

Referring to FIG. 7, OAM may be supported using an in-band scheme in a network including a root node and a plurality of leaf nodes.

In operation 710, the method may generate a merged OAM packet by merging a plurality of OAM packets received from the leaf nodes. Operation 710 may include an operation of merging a CC OAM packet and a CV OAM packet.

In operation 720, the merged OAM packet generated in operation 710 may be transmitted to the root node through an LSP.

Operation 720 may include an operation of assigning a BW to the LSP. Because only MP2P OAM packets may be merged and transmitted, only a BW required to transmit OAM packets may need to be secured. Accordingly, a 13W of an LSP may be set to a sum of BWs required to transmit OAM packets for each of LSPs to be merged.

A frame of an OAM packet may include a G-ACh field. The G-ACh field may be used to distinguish OAM control data from user data. Whether a G-ACh field is included in a packet may be indicated by a GAL. The GAL may be located on a bottom of a label stack.

An OAM packet may include a BFD control packet. Operation 720 may include an operation of verifying an address of the root node based on the BFD control packet. For example, an MPLS-TP BFD OAM packet may include source information of a root node and source information of a leaf node. In the BFD control packet, a My Discriminator field may be set to a value generated by a transmission system as a value of an ID of a node to generate and transmit an OAM packet, and a Your Discriminator field may be set to a value of an ID of a node to receive an OAM packet.

The method may further include processing, by the root node, the merged OAM packet. For example, the root node may receive, through a single LSP, an OAM packet generated by merging OAM packets received from the leaf nodes and thus, it is possible to more efficiently process the OAM packet.

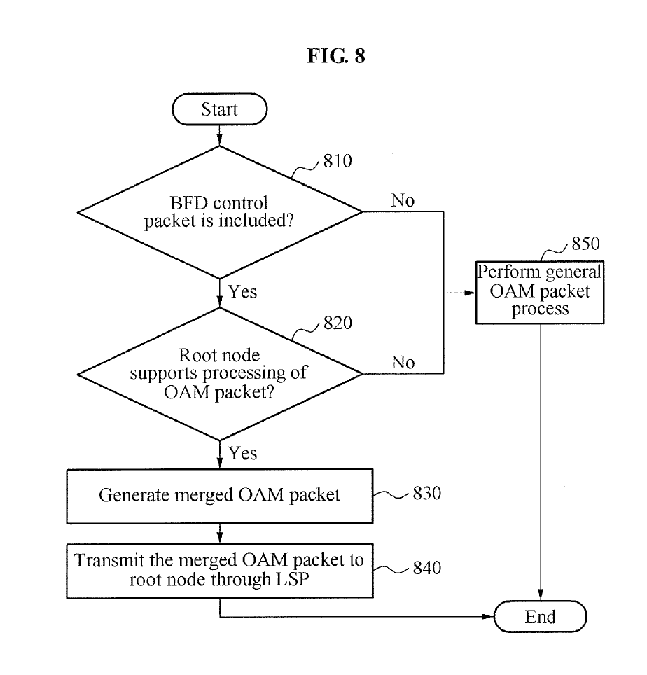

FIG. 8 is a flowchart illustrating a method of selecting an OAM support scheme in an MPLS-TP network in a router according to an embodiment.

Referring to FIG. 8, the router may determine whether merging of OAM packets is possible.

In operation 810, the router may determine whether an OAM packet includes a BFD control packet. For example, when an OAM packet is received, an LSR may determine whether the LSR has a function of supporting merging of OAM packets. When the LSR is determined to have the function, LSP merging of the OAM packets may be started. A frame of an OAM packet may include a G-ACh field, and the G-ACh field may be used to distinguish OAM control data from user data. Additionally, a G-ACh message may be defined in RFC 5586 of an MPLS-TP.

In operation 820, whether a root node supports processing of a merged OAM packet may be determined. An address of the root node may be verified based on Your Discriminator field information included in BFD control packet information.

When it is determined that the OAM packet includes the BFD control packet and that the root node supports processing of a merged OAM packet, a merged OAM packet may be generated by merging a plurality of OAM packets.

In operation 840, the merged OAM packet may be transmitted to the root node through an LSP. The address of the root node may be determined based on the BFD control packet. For example, an MPLS-TP BFD OAM packet may include source information of a root node and source information of a leaf node. In the BFD control packet, a My Discriminator field may be set to a value generated by a transmission system as a value of an ID of a node to generate and transmit an OAM packet, and a Your Discriminator field may be set to a value of an ID of a node to receive an OAM packet.

The router may assign a BW to the LSP. Because only MP2P OAM packets may be merged and transmitted, only a BW required to transmit OAM packets may need to be secured. Accordingly, a BW of an LSP may be set to a sum of BWs required to transmit OAM packets for each of LSPs to be merged.

When it is determined that the OAM packet does not include the BFD control packet or that the root node does not support processing of a merged OAM packet, the OAM may be performed through a general OAM packet process in operation 850.

In an example, a method of supporting in-band OAM in an MPLS-TP network may include determining whether an LSR supports merging of OAM packets. In another example, a method of supporting in-band OAM in an MPLS-TP network may include processing a merged OAM packet in a root node.

When OAM is supported in a P2MP data transfer scheme in an MPLS-TP network, OAM packets may be transmitted from leaf nodes to a root node in a P2MP by merging LSPs using an in-band scheme. Accordingly, OAM packets for protection switching within 50 milliseconds (ms) that is one of requirements of MPLS-TP OAM may be processed, in comparison to an out-of-band scheme requiring at least 1 second to support an OAM function. The root node may receive, through a single LSP, an OAM packet generated by merging the OAM packets received from the leaf nodes and thus, it is possible to more efficiently process the OAM packet.

The units described herein may be implemented using hardware components, software components, or a combination thereof. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of supporting Operations, Administration and Maintenance (OAM) in a network comprising a root node and a plurality of leaf nodes, the method comprising:
generating a merged OAM packet by merging a plurality of OAM packets received from the leaf nodes; and
transmitting the merged OAM packet to the root node through a Label-Switched Path (LSP).

2. The method of claim 1, wherein the generating comprises merging a Continuity Check (CC) OAM packet and a Connectivity Verification (CV) OAM packet.

3. The method of claim 1, wherein a frame of each of the OAM packets comprises a Generic Associated Channel (G-ACh) field, and
wherein the G-ACh field is used to distinguish OAM control data from user data.

4. The method of claim 1, wherein each of the OAM packets comprises a Bidirectional Forwarding Detection (BFD) control packet, and
wherein the transmitting comprises verifying an address of the root node based on the BFD control packet.

5. The method of claim 1, wherein the transmitting comprises assigning a Bandwidth (BW) to the LSP.

6. The method of claim 1, further comprising:
processing the merged OAM packet in the root node.

7. The method of claim 1, wherein the transmitting comprises transmitting the merged OAM packet via the same channel as a channel of a packet of user data.

8. A method of transmitting an Operations, Administration and Maintenance (OAM) packet in a network comprising a root node and a plurality of leaf nodes, the method comprising:
determining whether the OAM packet comprises a Bidirectional Forwarding Detection (BFD) control packet;
determining whether the root node supports processing of a merged OAM packet;
generating a merged OAM packet by merging a plurality of OAM packets, when the OAM packet is determined to comprise the BFD control packet and when the root node is determined to support processing of the merged OAM packet; and
transmitting the merged OAM packet to the root node through a Label-Switched Path (LSP).

9. The method of claim 8, wherein a frame of each of the OAM packets comprises a Generic Associated Channel (G-ACh) field, and
wherein the G-ACh field is used to distinguish OAM control data from user data.

10. The method of claim 8, wherein the transmitting comprises verifying an address of the root node based on the BFD control packet.

11. The method of claim 8, wherein the transmitting comprises assigning a Bandwidth (BW) to the LSP.

12. The method of claim 8, further comprising:
determining whether a Label Switching Router (LSR) supports merging of the OAM packets.

13. The method of claim 8, further comprising:
processing the merged OAM packet in the root node.

14. The method of claim 8, wherein the transmitting comprises transmitting the merged OAM packet via the same channel as a channel of a packet of user data.

15. A router for supporting Operations, Administration and Maintenance (OAM) in a network comprising a root node and a plurality of leaf nodes, the router comprising:
a processor to generate a merged OAM packet by merging a plurality of OAM packets received from the leaf nodes; and
a transmitter to transmit the merged OAM packet to the root node through a Label-Switched Path (LSP).

16. The router of claim 15, wherein the processor generates a merged OAM packet by merging a Continuity Check (CC) OAM packet and a Connectivity Verification (CV) OAM packet.

17. The router of claim 15, wherein a frame of each of the OAM packets comprises a Generic Associated Channel (G-ACh) field, and
wherein the G-ACh field is used to distinguish OAM control data from user data.

18. The router of claim 15, wherein each of the OAM packets comprises a Bidirectional Forwarding Detection (BFD) control packet, and
wherein the transmitter verifies an address of the root node based on the BFD control packet.

19. The router of claim 15, wherein the transmitter assigns a Bandwidth (BW) to each of LSPs of the merged OAM packet directed toward the root node.

20. The router of claim 15, wherein the transmitter transmits the merged OAM packet via the same channel as a channel of a packet of user data.
